(19) United States
(12) Patent Application Publication
(10) Pub. No.: US 2009/0144200 A1
(43) Pub. Date: Jun. 4, 2009

(54) MEDICAL CARE RECORD MANAGEMENT SYSTEM, MEDICAL CARE RECORD MANAGEMENT PROGRAM, AND MEDICAL CARE RECORD MANAGEMENT METHOD

(75) Inventor: Takashi YOSHIOKA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/328,367

(22) Filed: Dec. 4, 2008

(30) Foreign Application Priority Data
Dec. 4, 2007 (JP) 2007-313371

(51) Int. Cl. G06Q 50/00; H04L 9/32; G06Q 40/00

(52) U.S. Cl. 705/55; 705/2; 705/4; 705/3

(57) ABSTRACT

A medical care record management system for managing the records of medical care covered by an insurance performs the steps of acquiring first information that is information regarding the result of a medical care when a medical institution conducts the medical care for an insured person insured; acquiring second information that is information integrating the information regarding the insured person with an signature of an insurer of the insurance generated based on the information regarding the insured person; generating the third information that is information integrating the first information with an signature of the insured person by generating the signature of the insured person based on the first information; and generating the fifth information that is information integrating fourth information including the second information and the third information, with an signature of the medical institution by generating the signature of the medical institution based on the fourth information.

### TECHNICAL FIELD

The embodiment relates to a medical care record management system, a medical care record management program, and a medical care record management method for managing the records of medical care that can be covered by insurance.

### BACKGROUND OF INVENTION

With the development of the IT (Information Technology) systems in recent years, the introduction of a medical IT system has been actively promoted mainly in the large hospitals in the medical industry. The medical IT system may be an administrative information system for performing the computer processing of a Rezept (itemized statement of medical expenses) submitted to a payment fund or underwriter, a medical care support system such as an electronic patient's chart or ordering, or a system for community or remote medical care.

Further, in recent years, the introduction of an information system integrating all of them has rapidly been promoted mainly in the hospitals. Also, a full on-line system of Rezept (target of completion in 2011) was raised as a key theme for “Structural reform for medical care with IT” for the “New reform strategy of IT” in January 2006 in Japan, and it is expected that a national medical system using IT will be rapidly promoted in the future.

The Rezept on-line system involves digitizing or computerizing Rezept data claimed from the medical institution or the like, and tendering the Rezept to the payment fund and the underwriter using the information system and information communication technology. However, system investments are a great economical burden for medical institutions, and it is uncertain whether there is a merit such as business efficiency. For this reason, the penetration rate of the on-line Rezept is low, and in the existing circumstances, it is common to tender Rezepts off-line using the portable medium or paper.

As a prior related art of the invention, there is a medical prescription management method for outputting an alarm to take proper measures when there is a difference in the contents between the prescription of the doctor and the actual prescription of the dispensary (e.g., refer to Japanese Patent Laid-Open No. 2006-195526). Also, there is an electronic small settlement system that can make direct settlement between the dealers with full security (e.g., refer to Japanese Patent Laid-Open No. 7-85171).

### SUMMARY

A medical care record management system for managing the records of medical care covered by an insurance performs the steps of: acquiring the first information that is information regarding the result of medical care when a medical institution conducts the medical care on an insured person; acquiring the second information that is information integrating the information regarding the insured person with an digital signature of an insurer of the insurance generated based on the information regarding the insured person; generating the third information that is information integrating the first information with an digital signature of the insured person by generating the digital signature of the insured person based on the first information; and generating the fifth information that is information integrating fourth information including the second information and the third information, with an digital signature of the medical institution by generating the digital signature of the medical institution based on the fourth information.

### BRIEF DESCRIPTION OF THE DRAWINGS

FIG. 1 is a block diagram showing the configuration of a medical care record management proof system according to an embodiment;

FIG. 2 is a block diagram showing the configuration of a certification authority server according to an embodiment;

FIG. 3 is a block diagram showing the configuration of a medical institution server according to the embodiment;

FIG. 4 is a block diagram showing the configuration of an insurer server according to the embodiment;

FIG. 5 is a flowchart showing the operation of a public key registration process according to the embodiment;

FIG. 6 is a flowchart showing the operation of a process for digital signature added information according to the embodiment;

FIG. 7 is a flowchart showing the first operation of a medical care record management proof process according to the embodiment;

FIG. 8 is a flowchart showing the second operation of the medical care record management proof process according to the embodiment;

FIG. 9 is a view showing the insured person attributes with the digital signature of the insurer added according to the embodiment;

FIG. 10 is a view showing a medical care contents confirmation screen according to the embodiment;

FIG. 11 is a view showing an digital signature addition confirmation screen according to the embodiment;

FIG. 12 is a view showing a PIN code input screen according to the embodiment;

FIG. 13 is a view showing an digital signature addition completion screen according to the embodiment;

FIG. 14 is a view showing medical care information with the digital signature of the insured person added according to the embodiment;

FIG. 15 is a view showing Rezept information according to the embodiment;

FIG. 16 is a view showing master information according to the embodiment; and

FIG. 17 is a flowchart showing the operation of an examination/verification process according to the embodiment.

### BRIEF DESCRIPTION OF THE EMBODIMENT

First, a configuration of a medical care record management proof system (medical care record management system) according to the embodiment will be described below.

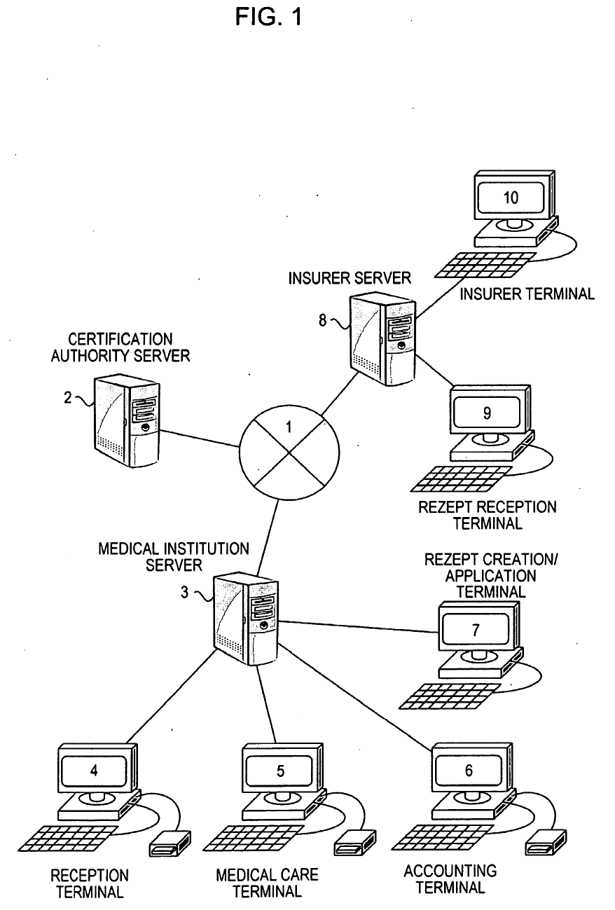

FIG. 1 is a block diagram showing the configuration of a medical care record management proof system according to the embodiment. The medical care record management proof system comprises an internet 1, and a certification authority server 2 that is the server of the certification authority for managing the digital signature information. The digital signature involves sending signature information in which a summary of signature object information is encrypted with a private key of the sender, the signature object information, and a public key certificate to the party at the other end. The recipient confirms the validity of the public key certificate, decrypts the encrypted signature information with the public key included in the public key certificate, and compares it with summary information obtained from the signature object information.

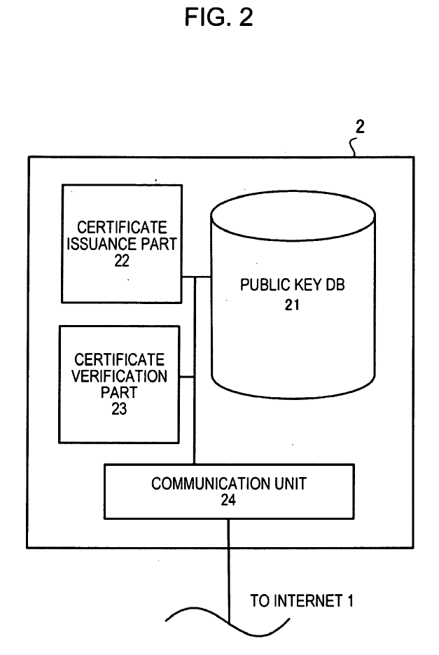

This system has a certification authority server 2 that accumulates the public keys of the medical institution, the insurer, and the insured person, because it is required to guarantee the legitimacy of the certificate. FIG. 2 is a block diagram showing the configuration of the certification authority server according to the embodiment. The certification authority server 2 has a public key DB 21 that accumulates the public keys of the medical institution, the insurer and the insured person; a certificate issuance part 22 for issuing the public key certificate as requested; a certificate verification part 23 for verifying the public key certificate; and communication unit 24 for making the communication via the internet 1.

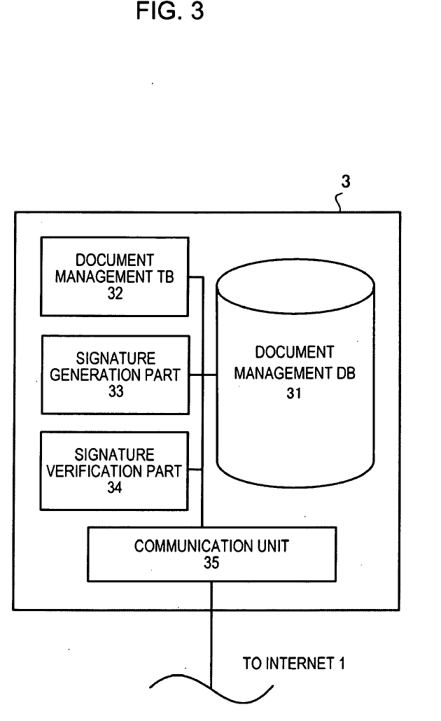

In this medical care record management proof system, the medical institution is provided with a medical institution server 3. FIG. 3 is a block diagram showing the configuration of the medical institution server according to the embodiment. The medical institution server 3 is the server for the person in charge of the medical institution to perform the operation. The medical institution server 3 has a document management DB 31 that accumulates information transmitted to an insurer server 8 as hereinafter described, a document management TB 32 for controlling the access to the document management DB31, a signature generation part 33 for adding an digital signature of the medical institution to the information, a signature verification part 34 for verifying the added digital signature, and communication unit 35 for making the communication via the internet 1.

A reception terminal 4 is a terminal for the person in charge of reception in the medical institution to operate the medical institution server 3. Also, a medical care terminal 5 is a terminal for the person in charge of medical care (doctor, nurse, and so on) in the medical institution to operate the medical institution server 3. Further, an accounting terminal 6 is the terminal for the person in charge of accounting in the medical institution to operate the medical institution server 3. Similarly, a Rezept creation/application terminal 7 is the terminal for the person in charge of Rezept creation and application in the medical institution to operate the medical institution server 3. Each of the reception terminal 4, the medical care terminal 5, the accounting terminal 6, and the Rezept creation/application terminal 7 can communicate with the medical institution server 3.

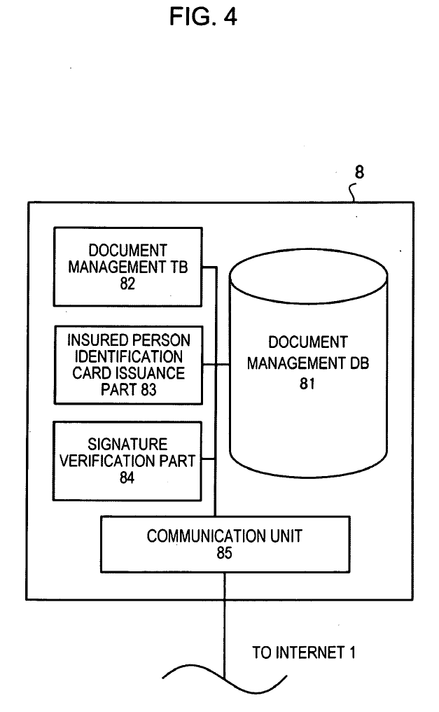

In the medical care record management proof system, an insurer institution is provided with an insurer server 8. FIG. 4 is a block diagram showing the configuration of the insurer server according to the embodiment. The insurer server 8 has a document management DB 81 that accumulates information transmitted to the medical institution server 3, a document management TB 82 for controlling the access to the document management DB81, an insured person identification card issuance part 83 for issuing an insured person identification card storing the personal information and the certificate of the insured person, a signature verification part 84 for verifying the digital signature added to the transmitted information, and a communication unit 85 for making communication via the internet 1.

A Rezept reception terminal 9 is the terminal for the person in charge of the insurer to operate the insurer server 8. An insurer terminal 10 is the terminal for the person in charge of the insurer to operate the insurer server 8.

In this embodiment, the following explanation is made on the premise that the insurer issues an insured person's identification IC (Integrated Circuit) card packaging an IC chip to the insured person, in which the personal information and the certificate are stored in the IC chip in the insured person identification card issuance part 83 within the insurer server 8. The IC card is a card incorporating an IC chip to make the recording or arithmetic operation of information. This card is also called a smart card or security card. The IC chip stored in this IC card has a semiconductor memory built in. Owing to the semiconductor memory, the amount of information storable in this IC card is tens to thousands times that of a conventional magnetic stripe card.

Further, a CPU or a coprocessor can be incorporated into this IC chip.

From this premise, the reception terminal 4, the medical care terminal 5 and the accounting terminal 6 include a device (hereinafter referred to as an IC card reader) for reading the insured person's identification IC card.

In this embodiment, it is premised that the personal information and the certificate are recorded and managed in the insured person's identification IC card. However, the information may be accumulated and managed within the insurer server 8 and accessed from the medical institution via the internet 1, as needed.

Next, an digital signature added information transmission process that is the process where the signature object information as an object of the digital signature is transmitted from a sending apparatus to a receiving apparatus will be described below.

The sending apparatus generates a key pair (private key and public key) in advance, and sends the public key to the certification authority server 2 to request the issuance of a public key certificate. The sending apparatus stores the private key and the public key certificate. In sending information, first of all, the sending apparatus generates the summary information of the signature object information, and encrypts this summary information with the private key of the sender to have signature information. Subsequently, the sending apparatus sends the signature object information, the signature information, and the public key certificate of the sender to the party at the other end. The party at the other end (receiving apparatus) receiving the information verifies the validity of the acquired public key certificate of the sender through the certification authority server 2, and decrypts the signature information with the public key if the validity is verified. The receiving apparatus subsequently generates the summary of the signature object information and compares it with the decrypted information, in which if the information matches, it may be proven that the information is truly the one sent from the sender and has not been altered.

Here, the summary information is information (Hash information) calculated from the signature object information, using a cryptographic one-way Hash function, and also called a message digest in the sense that the size of signature object information can be compressed. Also, the Hash information generated by the cryptographic one-way Hash function is the unique information that can be generated from the signature object information only, and has a feature that the original information cannot be restored from the generated Hash information. Therefore, it is often used for encrypting information or generating the digital signature. This cryptographic one-way Hash function has algorithms such as MD5, SHA-1 and SHA-256. The information (Hash information generation algorithm) as to which algorithm is used to generate the summary information (Hash information) from the signature object information is described in the public key certificate.

The details of the digital signature added information transmission process will be described below. The digital signature added information transmission process comprises a public key registration process and a sending process with the sending apparatus and a receiving process and a verification process with the receiving apparatus.

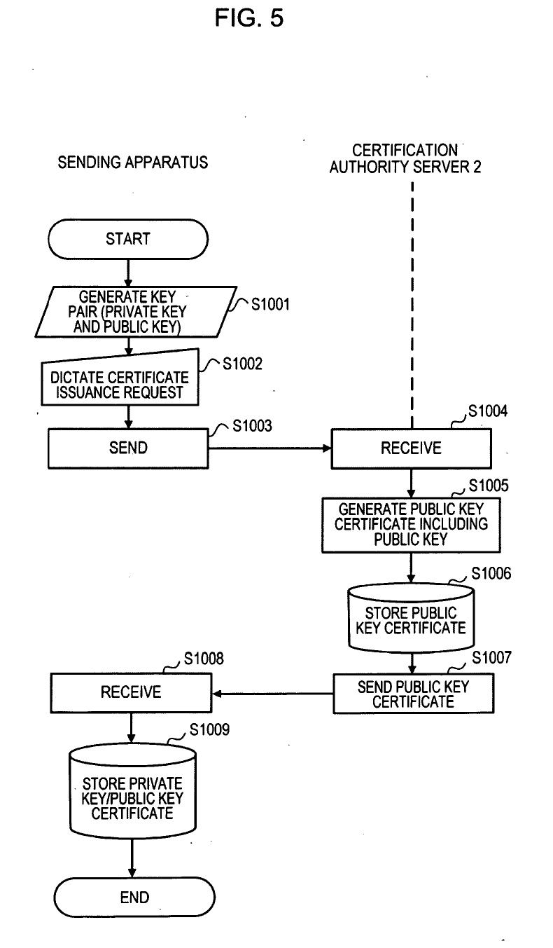

First, a public key registration process between the sending apparatus and the certification authority server 2 will be described below. FIG. 5 is a flowchart showing the operation of the public key registration process according to the embodiment. In this embodiment, the medical institution server 3 is the sending apparatus of digital signature.

First, the sending apparatus generates a key pair (private key and public key) in accordance with an operation of the sender (S1001). Subsequently, if the sender inputs certificate issuance request information into the sending apparatus (S1002), the sending apparatus transmits the inputted certificate issuance request information together with the public key to the certification authority server 2 (S1003).

The certificate issuance part 22 of the certification authority server 2 receives this information through the communication unit 24 (S1004), generates a public key certificate including the public key (S1005), and accumulates the generated public key certificate in the public key DB 21 (S1006).

Thereafter, the certificate issuance part 22 controls the communication unit 24 to transmit the issued public key certificate via the internet 1 to the sending apparatus that sends the certificate issuance request information (S1007).

The sending apparatus receives this information (S1008), and accumulates the private key generated at S1001 and the public key certificate issued from the certification authority server 2 in a storage unit (storage area within the signature generation part 33 of the medical institution server 3) in the sending apparatus itself (S1009), whereby the process is ended.

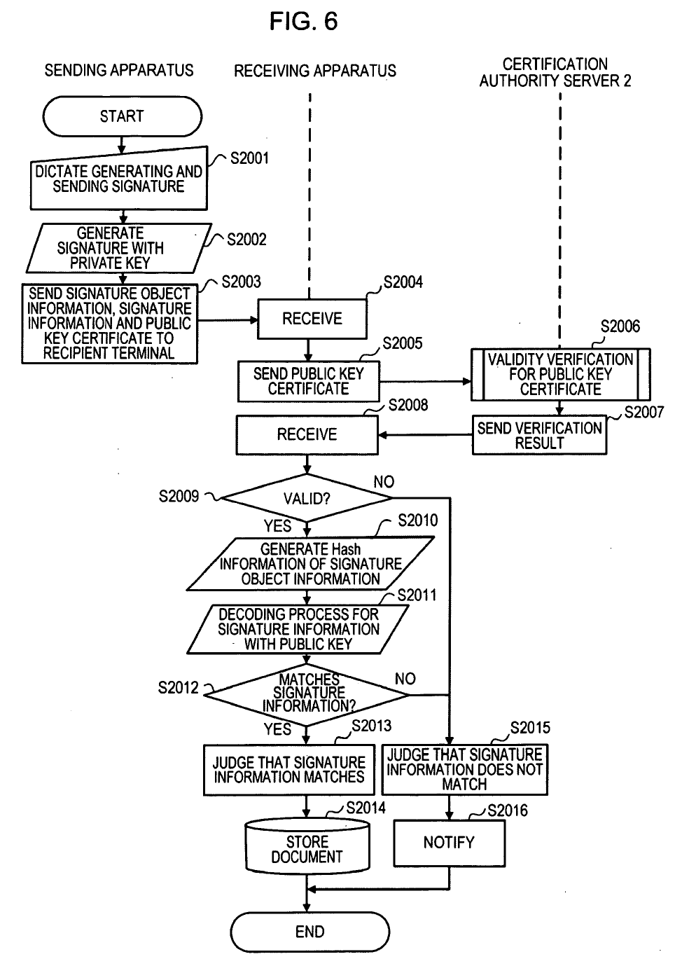

Next, a sending process for digital signature added information with the sending apparatus and a receiving process and a verification process with the receiving apparatus will be described below. FIG. 6 is a flowchart showing the operation of a process for digital signature added information according to the embodiment.

First, the sender inputs a sending instruction into the sending apparatus to generate the digital signature for the signature object information and then sends it to the receiving apparatus (S2001). The sending apparatus encrypts the summary information (Hash information) of the designated signature object information with the private key stored in the storage area (S2002), and sends it together with the public key certificate also stored to the receiving apparatus (S2003).

The receiving apparatus receives the information (S2004), and firstly sends the public key certificate to the certification authority server 2 to confirm the term of validity and the lapse information of the transmitted public key certificate (S2005). Here, the certification authority server 2 supports one series of functions of issuing the certification and verifying the certification. Then, the certification authority server 2 verifies the validity of the received public key certificate (S2006), and sends the verification result to the receiving apparatus (S2007).

Then, the receiving apparatus receives the validity verification result (S2008). Subsequently, the receiving apparatus receiving the validity verification result confirms whether or not it is valid (S2009). If the validity is confirmed (S2009, YES), the receiving apparatus firstly generates the Hash information from the signature object information received from the sending apparatus by referring to the Hash information generation algorithm included in the public key certificate of the sender acquired from the sending apparatus (S2010). Subsequently, the receiving apparatus performs a decryption process for the signature information received from the sending apparatus, using the public key included in the public key certificate (S2011). The receiving apparatus compares the Hash information generated at S2010 and the hash information obtained through the decryption process at S2011 to judge whether or not they match (S2012). If the receiving apparatus confirms that they match in this judgment (S2012, YES), the receiving apparatus judges that there is proof that the information sent from the sending apparatus (sender) has not been altered (S2013), and stores the information (S2014).

Conversely, if the validity verification result is not valid (S2009, NO), or the generated Hash information and the decrypted information are different (S2012, NO), the receiving apparatus judges that there is no proof that the information is from the sending apparatus (sender), or that there is proof that the information may have been altered in the course of communication (S2015), and makes a notification process for indicating that the information from the sending apparatus is not verified to the operator of the receiving apparatus (S2016). Similarly, if the validity of the public key certificate cannot be confirmed at step S2009, the receiving apparatus judges that there is no proof that the information is from the sending apparatus (sender) (S2015), and makes a notification process for indicating that the information from the sending apparatus is not verified to the operator of the receiving apparatus (S2016).

Next, the operation of a medical care record management proof process with the medical care management proof system according to the embodiment will be described below.

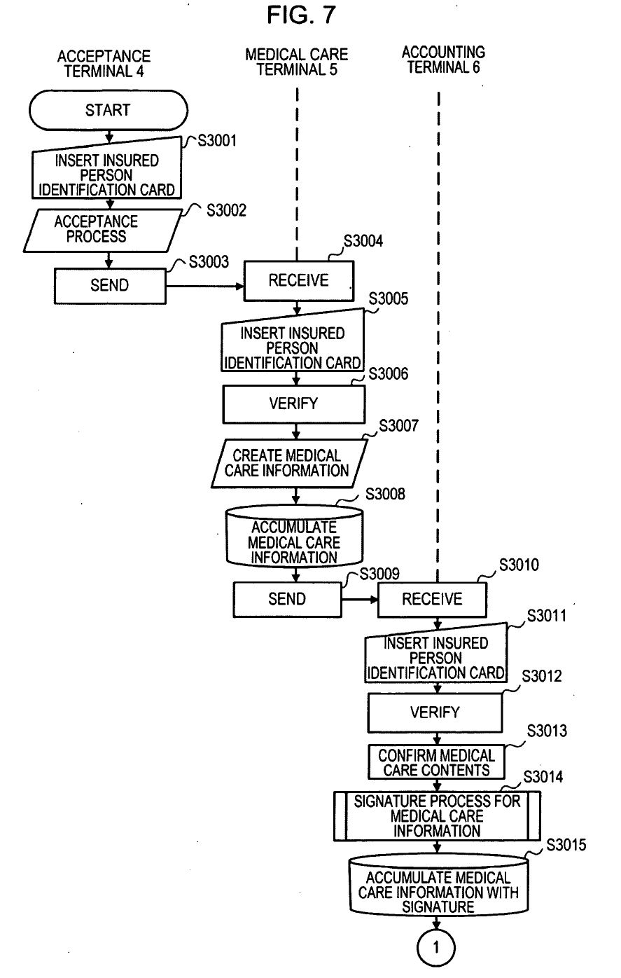

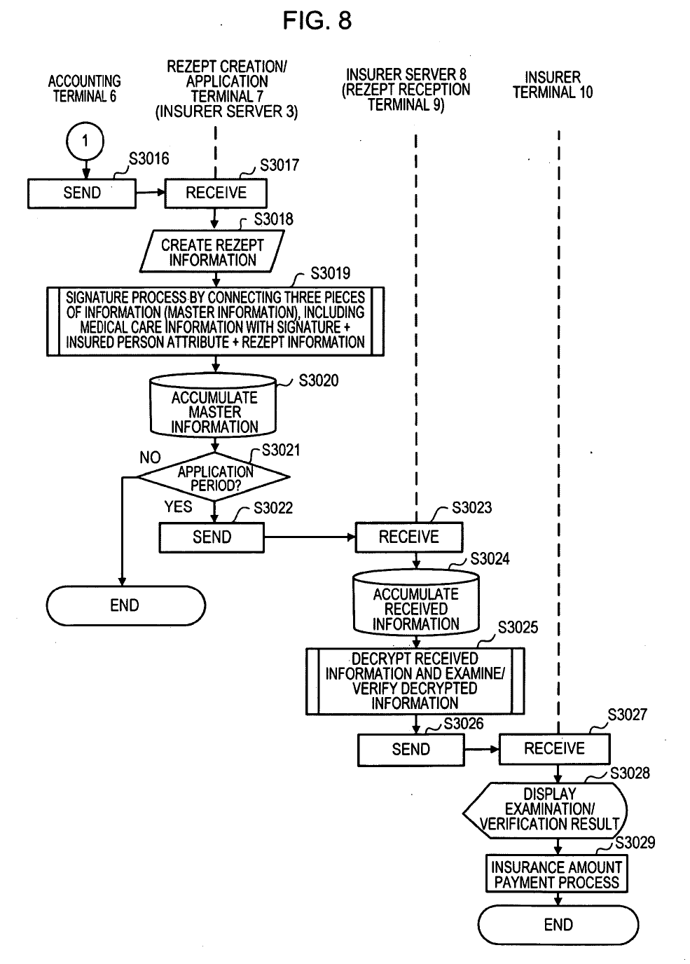

FIGS. 7 and 8 are flowcharts showing the operation of the medical care record management proof process according to the embodiment.

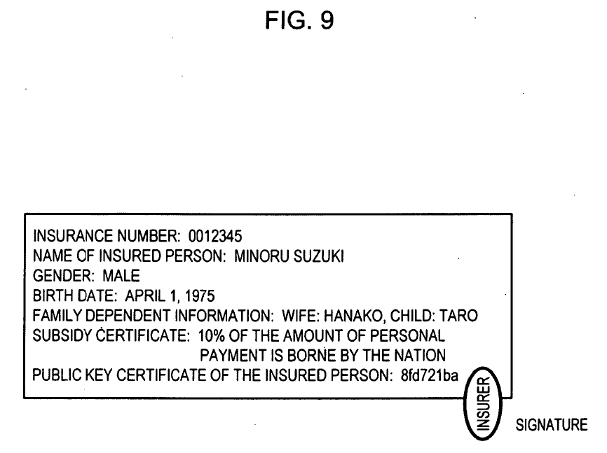

At first, the insurer issues an insured person's identification IC card storing the information (second information) that includes the insured person attributes (information regarding the insured person) and the digital signature of the insurer for the insured person attributes to the insured person. The insured person attributes may include an insurance number, name of insured person, gender, date of birth, subsidy certificate, and public key certificate of the insured person, for example. FIG. 9 is a view showing an example of the insured person attributes to which the digital signature of the insurer is added according to the embodiment. The insured person's identification IC card stores the insured person attributes to which the digital signature of the insurer is added.

Here, the method for adding the digital signature of the insurer to the insured person attributes corresponds to the process of the sending apparatus in the digital signature added information transmission process, and the insurer server 8 corresponds to the sending apparatus.

In this embodiment, the certification authority server 2 and the insurer are linked. The insured person creates the key pair of the private key and the public key for the insured person. The private key is stored in the IC chip for the digital signature of the insured person, and the public key is managed by the certification authority server 2. In this example of the insured person attributes as shown in FIG. 9, the public key certificate of the insured person is represented as “8fd721ba”, and this value is also stored in the IC chip. Also, the subsidy certificate refers to a certificate certifying that 10% of the amount of personal payment is borne by the nation or the local government. This subsidy certificate is appended upon the application of the insured person himself or herself to the nation or the local government. The insured person's identification IC card may be updated at any time as necessary.

First of all, the insured person having the insured person's identification IC card goes to the medical institution and is accepted at a reception counter. At the time of reception, for example, the insured person may insert the insured person's identification IC card issued from the insurer into the IC card reader at the reception terminal 4 (S3001) in FIG. 7. Here, a code number (hereinafter referred to as a PIN (Personal Identification Number) code) for confirming the owner of the IC card is already set by the owner himself or herself. In the example, when the owner inserts the card or makes an operation (that is, accesses the inside of the IC chip), the owner inputs the PIN code into an input device of the reception terminal 4, so that the reception terminal 4 can confirm that the insured person's identification IC card is owned by the owner thereof.

Subsequently, the reception terminal 4 performs a reception process (S3002). Here, the reception process refers to the process for the reception terminal 4 to extract the insured person attributes with the digital signature of the insurer added from the insured person's identification IC card, verify the insured person attributes, and confirm that the insured person's identification IC card is issued by the insurer.

More specifically, the document management TB 32 within the medical institution server 3 enables the signature verification part 34 to perform a verification process for the digital signature for the extracted insured person attributes. In this verification process, the digital signature added information is not transmitted over the internet 1. Even if the digital signature is added beforehand to the insured person's identification IC card, the above verification process is enabled. Hence, if the verification process is successful, it is confirmed that the information is from the right insurer, and the decrypted insured person attributes can be extracted and utilized. If the insured person attributes are not decrypted in this verification process, the document management TB 32 notifies the reception terminal 4 that an error has occurred and stops the process. Also, the reception terminal 4 performs a process for notifying the person in charge of reception of the error, such as by displaying the error on a display device.

If the reception process is normal, the reception terminal 4 subsequently sends the information indicating acceptance and the insured person attributes extracted from the insured person's identification IC card to the medical care terminal 5 (S3003).

When the reception process is completed, the insured person receives his or her identification IC card from the person in charge of reception, and then moves to the applicable medical department to receive medical care.

The medical care terminal 5 in the applicable department receives the information indicating acceptance and the insured person attributes from the reception terminal 4 (S3004). The insured person, for example, inserts the insured person's identification IC card into an IC card reader at the medical care terminal 5 in the applicable medical department (S3005), and inputs the PIN code for confirmation of the identity using an input device of the medical care terminal 5. The medical care terminal 5 verifies the insured person attributes sent from the reception terminal 4 (S3006) if it is confirmed that the insured person's identification IC card is owned by the owner thereof with the input of the PIN code. If a match occurs by this verification, it may be confirmed that the person is the one who has been accepted at the reception terminal 4.

The insured person receives a diagnosis by a doctor in the applicable department, and the doctor in charge inputs the medical care information (first information) of the diagnosis at the medical care terminal 5 (S3007). Subsequently, the medical care information is accumulated in the document management DB 31 via the document management TB 32 within the medical institution server 3 (S3008, process of the first information acquisition part). After completion of creating and accumulating the medical care information and completion of all the medical care, the medical care terminal 5 sends the information indicating that the medical care is completed and the insured person attributes extracted from the insured person's identification IC card to the accounting terminal 6 (S3009). The insured person receives his or her identification IC card from the doctor in charge and then moves to the cashier.

The accounting terminal 6 receives the information indicating that the medical care is completed and receives the insured person attributes from the medical care terminal 5 (S3010). The insured person, for example, inserts his or her identification IC card into the IC card reader at the accounting terminal 6 (S3011), and inputs the PIN code for confirmation of the identity using an input device at the accounting terminal 6. The accounting terminal 6 verifies the insured person attributes sent from the medical care terminal 5 (S3012, process for the second information acquisition part) if it is confirmed that the insured person's identification IC card is owned by the owner thereof with the input of the PIN code. If a match occurs by this verification, the accounting terminal 6 can confirm that the person is the one who received the medical care and the medical care is completed. After confirmation, the accounting terminal 6 extracts the medical care information accumulated in the document management DB 31 within the medical institution server 3, changes the medical care information into information that can be understood by the insured person, and displays the changed medical care information in a medical care contents confirmation screen on the display unit at the accounting terminal 6.

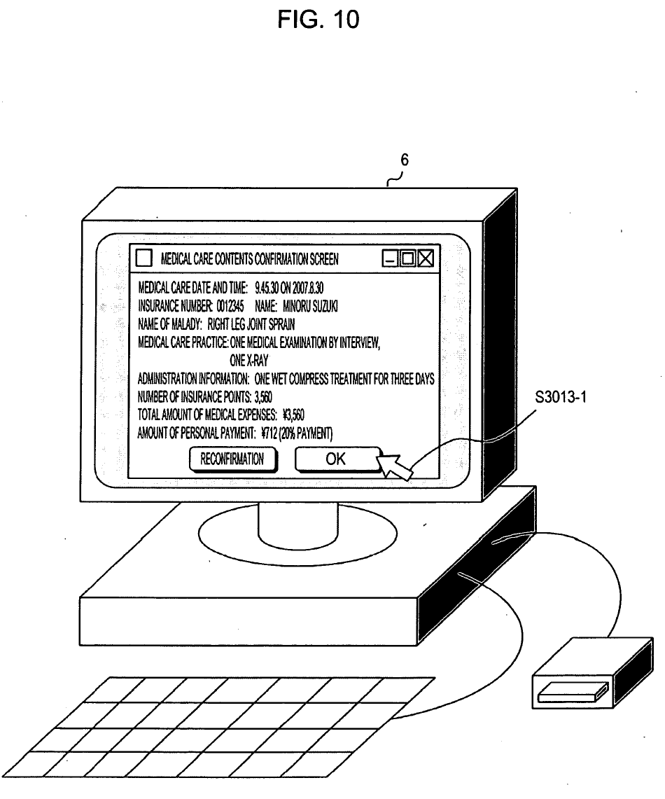

Here, the insured person confirms the contents of medical care at this time by referring to the medical care information displayed on the display unit of the accounting terminal 6 (S3013). FIG. 10 is a view showing the medical care contents confirmation screen according to the embodiment. The medical care contents confirmation screen may display the medical care date and time, insurance number, name, disease name, medical care practice, administration information, number of insurance points, total medical expenses, and amount of personal payment, for example. The insured person can confirm the display contents and consistency with the actual medical care received.

As previously described, the accounting terminal 6 changes the medical care information into the contents understandable by the insured person. The changed information is different from the contents of medical care information input by the doctor in charge, and is meant to be displayed in a descriptive manner that the nonprofessional insured person can confirm by excluding medical specialist vocabulary, since it is desired that the medical care information after being changed is represented in a manner easily understood by the insured person. For example, an insured person can easily understand if the medical care practice is represented as one medical care interview and one X-ray as displayed in the medical care contents confirmation screen of FIG. 9.

In the example of the medical care contents confirmation screen in FIG. 9, the amount of personal payment is 20%. Usually, the amount of personal payment is 30%, but if the subsidy certificate indicates that 10% of the amount of personal payment is borne by the nation or local government by referring to the subsidy certificate (insured person attribute) extracted from the insured person's identification IC card, the amount of personal payment is recognized as 20%. In this example, ¥712 that is 20% of the total amount of medical expenses ¥3,560 is displayed as the amount of personal payment for the insured person.

In this way, the confirmation of the insured person is made at this time using the insured person attributes stored in the insured person's identification IC card. Since the confirmation is made at this time, the follow-up confirmation for the insured person is unnecessary. Also, the creation of fictitious medical care information by the medical institution can be prevented. If the displayed medical care information is not correct, the insured person informs the person in charge of accounting that there are some deficiencies, and clicks a reconfirmation button to treat the error or errors. On the other hand, if the displayed medical care information is correct, the insured person clicks an OK button (S3013-1), and pays ¥712 as the amount of personal payment.

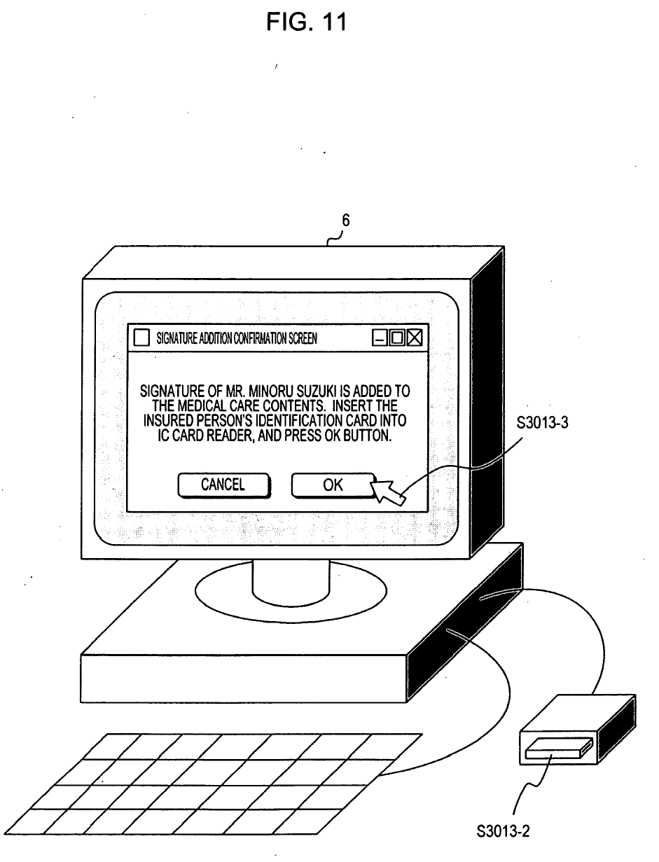

When the OK button is clicked, the accounting terminal 6 subsequently displays an digital signature addition confirmation screen on the display device. FIG. 11 is a view showing the digital signature addition confirmation screen according to the embodiment. At this time, the insured person confirms that his or her identification IC card, for example, is inserted into the IC card reader at the accounting terminal 6 (S3013-2), and subsequently clicks the OK button (S3013-3).

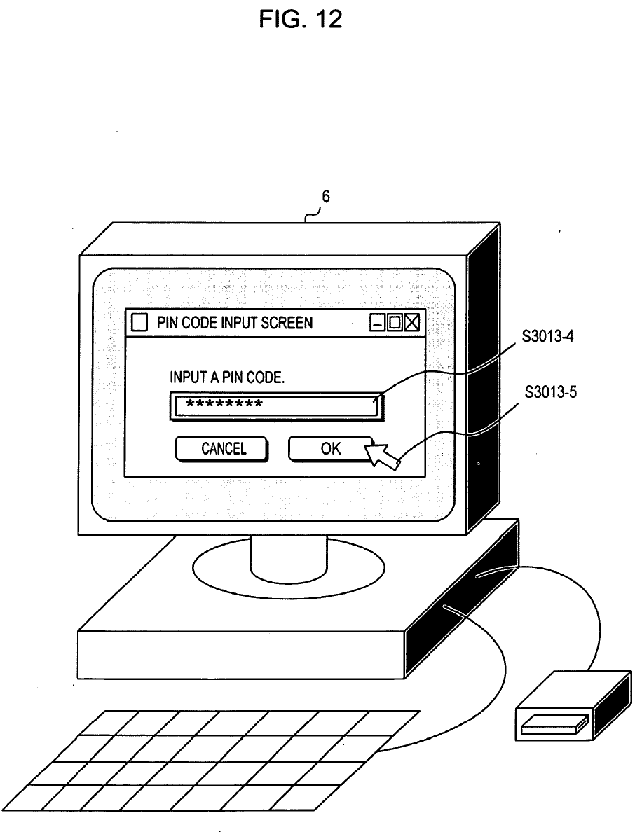

If the OK button is clicked, the accounting terminal 6 displays a PIN code input screen. FIG. 12 is a view showing the PIN code input screen according to the embodiment. Here, the insured person inputs the PIN code corresponding to his or her identification IC card using an input device at the accounting terminal 6 (S3013-4).

In this embodiment, the accounting terminal 6 prompts for the input of the PIN code again at the time of adding the digital signature. The insured person clicks the OK button after completing the input of the PIN code (S3013-5). If the input of the PIN code is completed and the OK button is clicked, the accounting terminal 6 adds the digital signature of the insured person to the medical care information (S3014, process for the third information generation part).

Here, the method for adding the digital signature of the insured person to the medical care information corresponds to the process of the sending apparatus in the digital signature added information transmission process, and the medical institution server 3 corresponds to the sending apparatus.

In this way, the confirmation by the insurer is enabled. Since it is assumed that the private key for adding the digital signature cannot be known by a third party or even the insured person himself or herself, it is preferable that the private key is stored in an IC chip that does not permit falsification or analysis. Also, the public key corresponding to the private key is managed by the insurer or the certification authority server 2 used by the insurer, whereby the verification process for digital signature is enabled.

Since the insured person's identification IC card is physically carried by the owner of the card, and furthermore, the PIN code for gaining access to the private key within the insured person's identification IC card may only be known by the owner of the card and thus inputted by the owner of the card, it is possible to prevent a third party from pretending to be the owner and adding the digital signature illegally. That is, with this embodiment, it is very difficult for a medical institution to pretend to be an insured person to create fictitious medical care information.

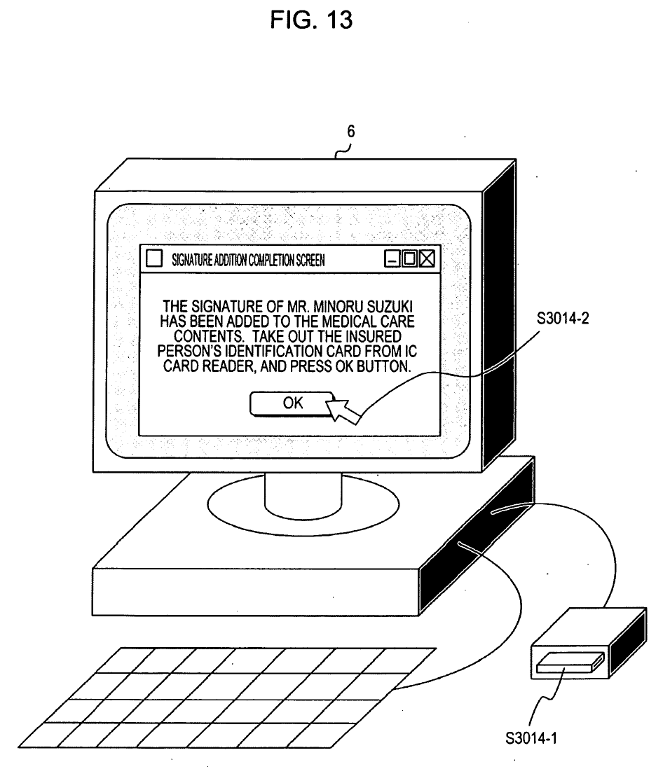

When the addition process for the digital signature is completed, the accounting terminal 6 displays an digital signature addition completion screen. FIG. 13 is a view showing the digital signature addition completion screen according to the embodiment. When the digital signature addition completion screen is displayed, the insured person takes out the insured person's identification IC card from the IC card reader (S3014-1), and clicks the OK button (S3014-2). When the OK button is clicked, the accounting terminal 6 accumulates the medical care information (third information) with the digital signature added via the document management TB 32 within the medical institution server 3 in the document management DB 31 (S3015).

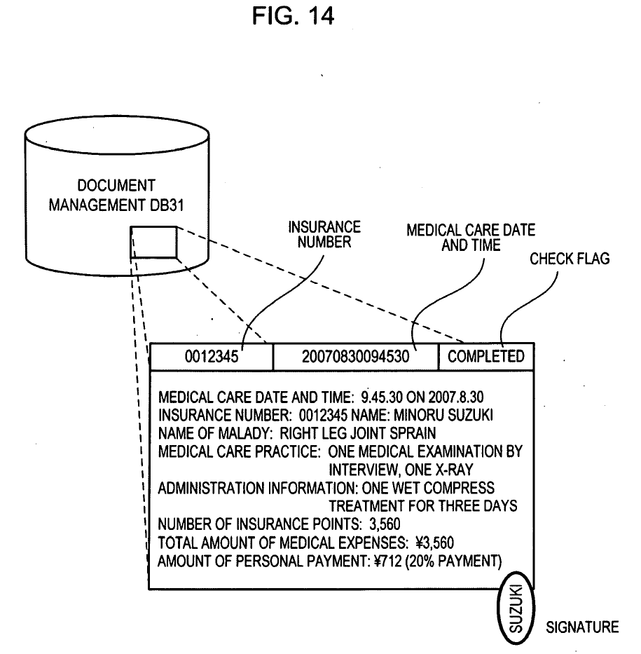

At this time, the document management DB 31 overwrites the medical care information accumulated at S3008, but may hold each medical care information before and after adding the digital signature. FIG. 14 is a view showing medical care information with digital signature of the insured person added according to the embodiment. The medical care information is provided with a retrieval tag and a check flag. In an example of FIG. 14, two pieces of information including the insurance number and the medical care date and time as the retrieval tag are employed, making it possible to identify who the medical care information belongs to and when it was generated. Using the retrieval tag, the medical care information being currently processed can be specified. Also, the check flag indicating whether the Rezept creation/application is “completed” or “not yet” processed is provided and used to confirm the medical care information not created.

If accumulation of the medical care information with digital signature added is completed, the accounting terminal 6 sends the information indicating that the digital signature is already added to the medical care information and sends the insured person attributes extracted from the insured person's identification IC card to the Rezept creation/application terminal 7 (S3016). The Rezept creation/application terminal 7 receives the information indicating that the digital signature is already added to the medical care information and receives the insured person attributes from the accounting terminal 6 (S3017).

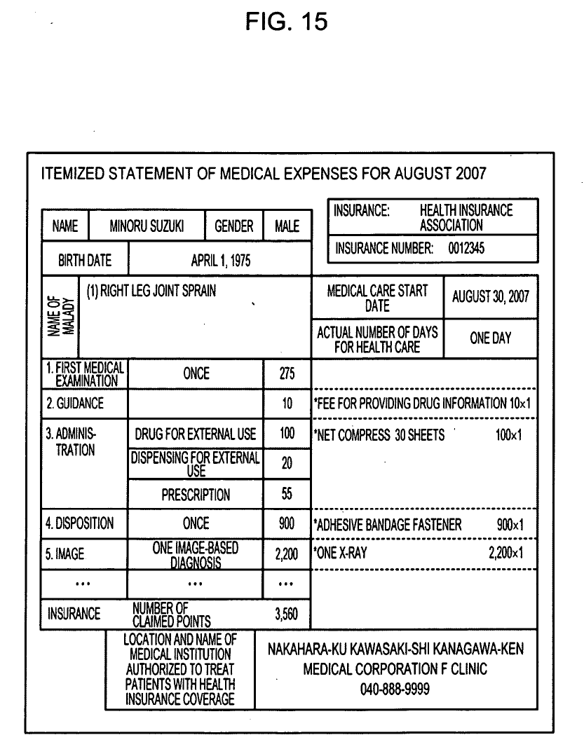

The Rezept creation/application terminal 7 extracts the medical care information with the digital signature of the insured person added accumulated in the document management DB 31 via the document management TB 32 within the medical institution server 3, based on the received insured person attributes. Then, the Rezept creation/application terminal 7 creates the Rezept information for applying to the insurer (S3018), after confirming that the medical care information extracted is “not yet” processed in the Rezept creation/application. This confirmation is allowed by confirming the check flag indicating whether or not the Rezept creation/examination is already processed. FIG. 15 is a view showing Rezept information according to the embodiment. The Rezept information includes the same contents as the medical care information.

Subsequently, the Rezept creation/application terminal 7 combines three pieces of information, including the medical care information with digital signature of the insured person added extracted from the document management DB 31 within the medical institution server 3, the insured person attributes with digital signature of the insurer added sent from the accounting terminal 6, and the Rezept information created at S3018, to form the master information (fourth information), and adds the digital signature of the medical institution to the master information (S3019, process for the fifth information generation part). In this embodiment, the created Rezept information does not have the digital signature of the creating medical institution added. This is because the digital signature of the medical institution is added to the master information including the Rezept information, as previously described, thereby preventing the redundant data retention. To realize the strict validity assurance of the Rezept information, the digital signature of the medical institution may be added to the master information.

Here, the method for adding the digital signature of the medical institution to the master information corresponds to the process of the sending apparatus in the digital signature added information transmission process, and the medical institution server 3 corresponds to the sending apparatus.

The master information (fifth information) to which the digital signature of the medical institution is added is accumulated via the document management TB 32 within the medical institution server 3 in the document management DB 31 (S3020). The Rezept creation/application terminal 7 judges whether or not it is the Rezept application time (S3021), and if it is the application time (S3021, YES), a message to that effect is displayed on the display device of the Rezept creation/application terminal 7.

The person in charge of the Rezept creation/application confirms a Rezept application process for the insurer by seeing the display on the Rezept creation/application terminal 7. If the Rezept application process is confirmed, the medical institution server 3 transmits the master information with the digital signature of the medical institution added via the communication unit 35 to the insurer server 8 (S3022). If it is not the application time (S3021, NO), this flow is ended. Regarding the Rezept application time, the Rezept of each insured person is usually created on a monthly basis, and the application for each insurer is made at the deadline of the next month (usually by the 10^{th} day).

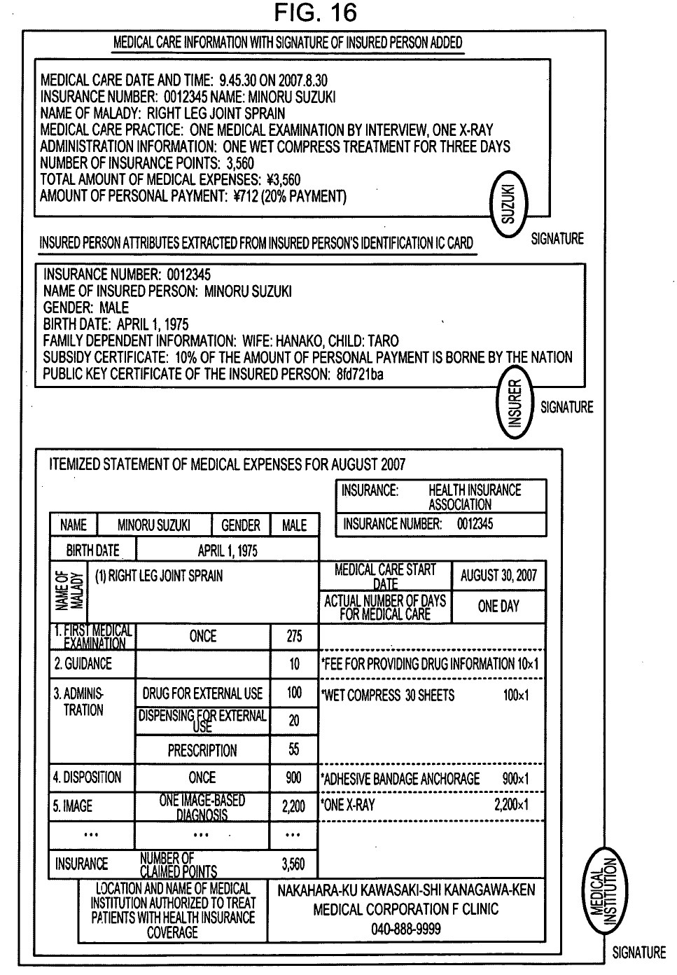

The insurer server 8 receives the master information transmitted from the medical institution server 3 via the communication unit 85 (S3023), and displays a message of reception completion on the display device of the Rezept reception terminal 9. FIG. 16 is a view showing an example of the master information according to the embodiment. The master information may include the medical care information, the insured person attributes, and the Rezept information as described above.

If the person in charge of the Rezept creation/application confirms a reception process using the Rezept reception terminal 9, the Rezept reception terminal 9 accumulates the master information via the document management TB 82 within the insurer server 8 in the document management DB 81 (S3024). Thereafter, the document management TB 82 within the insurer server 8 allows the signature verification part 84 to perform a verification process for the digital signature of the accumulated master information (S3025).

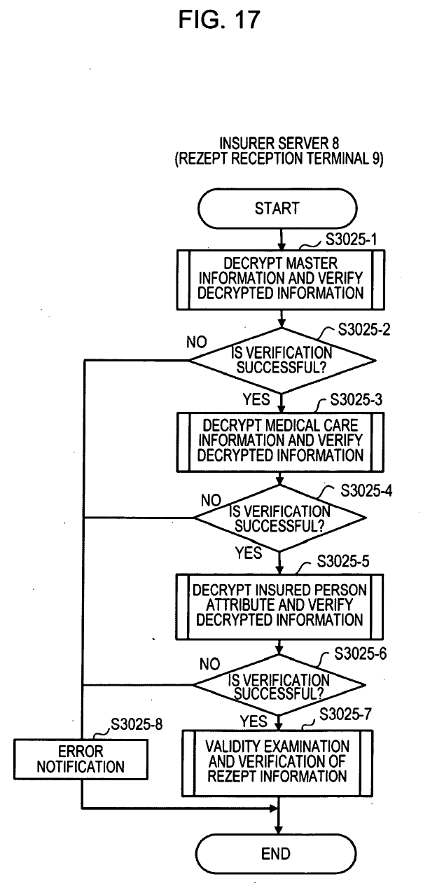

Here, the signature verification part 84 performs an examination/verification process using the received master information (three pieces of information including the medical care information, the insured person attributes and the Rezept information) (S3026). FIG. 17 is a flowchart showing the operation of the examination/verification process according to the embodiment. More specifically, first, the master information with digital signature of the medical institution added is verified (S3025-1). The digital signature verification process is the process for actually making the digital signature verification to verify that the information is transmitted from the party at the other end, namely, the medical institution, as described above.

Here, the method for verifying the digital signature of the medical institution added to the master information corresponds to the process of the receiving apparatus in the digital signature added information transmission process, and the insurer server 8 corresponds to the receiving apparatus.

Hence, if this verification process is successful (S3025-2, YES), that is, if it is confirmed that the information is from the right party at the other end, the Rezept reception terminal 9 acquires the decrypted master information, namely, three pieces of information including the medical care information with digital signature of the insured person added, the insured person attributes with digital signature of the insurer added, and the Rezept information, from the document management TB 82. On the other hand, if the master information is not decrypted through this process (S3025-2, NO), the document management TB 82 reports an error to the Rezept reception terminal 9 to stop the process. Further, the Rezept reception terminal 9 performs a process for notifying the error to the person in charge of the Rezept reception, such as displaying the error on a display device (S3025-8).

Subsequently, the Rezept reception terminal 9 verifies the digital signature added using two pieces of information including the medical care information with digital signature of the insured person added and the insured person attributes with digital signature of the insurer added. This is also made by confirming the creator of information and the validity with the digital signature added to each information, like the master information with digital signature of the medical institution added. This verification method for digital signature is the same as the verification of the master information with the digital signature of the medical institution added, in which the document management TB 82 within the insurer server 8 allows the signature verification part 84 to perform the verification process of the digital signature of the medical care information (S3025-3) and the verification process of the digital signature of the insured person attributes (S3025-5).

Here, the method for verifying the digital signature of the insured person added to the medical care information corresponds to the process of the receiving apparatus in the digital signature added information transmission process, and the insurer server 8 corresponds to the receiving apparatus. Similarly, the method for verifying the digital signature of the insurer added to the insured person attributes corresponds to the process of the receiving apparatus in the digital signature added information transmission process, and the insurer server 8 corresponds to the receiving apparatus.

If both the verification processes are successful (S3025-6, YES), the document management TB 82 notifies the Rezept reception terminal 9 that the information is from the right party at the other end, and the validity of the decrypted medical care information and the insured person attributes is confirmed. On the other hand, if the information is not decrypted through any of these verification processes (S3025-4, NO, S3025-6, NO), the document management TB 82 reports an error to the Rezept reception terminal 9 to stop the process. Further, the Rezept reception terminal 9 performs a process for reporting the error to the person in charge of the Rezept reception such as displaying the error on a display device (S3025-8).

If the verification process for medical care information (S3025-3) and the verification process for insured person attributes (S3025-5) are successful through the above processing, the insurer can confirm that the insured person is the right insured person managed by the insurer, namely, the insured person himself or herself, and at which medical institution and when the insured person receives the medical care to approve the medical care information. That is, it is proven that the insured person has come to the medical institution and received the medical care.

In the example of master information as shown in FIG. 16, the insured person attributes include the subsidy certificate indicating that 10% of the amount of personal payment is borne by the nation, whereby it is confirmed that the insured person bears 20% of the total amount of medical expenses (usually 30% of personal payment) and pays 712 yen.

Subsequently, the Rezept reception terminal 9 confirms the validity of the Rezept information (S3025-7). More specifically, the validity is confirmed as to whether or not the medical practice and the medication information are improperly declared or applied for, namely, whether the medical care information and the Rezept information match or not based on the medical care information approved by the insured person. The validity of medical care information and the insured person attributes has been already confirmed, as previously described, and their validity can be proven.

The effects with the above examination/verification process will be described below. First of all, the identification of the insured person and the validity confirmation of the insured person attributes can be made by verifying the digital signature added to the medical care information and the insured person attributes. Also, since the insured person adds the digital signature to the medical care information, the validity of the master information can be confirmed. Since the medical institution adds the digital signature to the master information, it may be confirmed that there is no illegal claim by the medical institution. Also, the matching of medical care information with the Rezept information and the validity of the insured person attributes can be confirmed by verifying the digital signature added to the master information, whereby the validity of the amount claimed for the insurer can be confirmed.

In the example of master information as shown in FIG. 16, it is confirmed that the insurance bill (amount claimed for the insurer is 70%) that the insurer pays to the medical institution (F clinic) to the Rezept claim is ¥2,492, which is 70% of the total amount of medical expenses ¥3,560.

If the examination/verification process is completed, the Rezept reception terminal 9 sends the examination/verification result to the insurer terminal 10 (S3026). Then, the insurer terminal 10 receives this examination/verification result (S3027). This examination/verification result is displayed on the display device of the insurer terminal 10, and sent to the person in charge of the insurer (S3028). The person in charge of the insurer confirms the process for paying the notified amount of insurance bill to the medical institution at the insurer terminal 10 (S3029).

Also, in the example of master information as shown in FIG. 16, 10% of the amount of personal payment is borne by the nation as the subsidy certificate, and for this claim, the master information is transmitted from the medical institution to the administrative organ (nation or local government). In this example, the administrative organ receives the master information, whereby it is confirmed that the subsidy amount (amount claimed for the administrative organ with subsidy) that the administrative organ pays the medical institution (F clinic) for this master information is ¥356, which is 10% of 3,560 yen.

With this embodiment as described above, when the electronic document is circulated through many organizations in an online Rezept process in the medical industry, assurance of electronic document original and proof of the creator of electronic document can be made. More specifically, the insurer can confirm when (medical care date and time) and what (medical care information) the insured person approved. Also, the insurer can confirm the validity of the Rezept information claimed and presented to the insurer. Also, the insurer can confirm the correspondence between the medical care information and the Rezept information. Accordingly, the insurer can amend the insurance fee paid by the insurer without making the follow-up confirmation for the insured person as conventionally performed. The insurer can also contribute to the suppression of illegal billing by detecting and preventing illegal billing (fictitious billing, padded-out billing, double billing, etc.) on the medical institution side.

Further, a program for performing each of the above steps on a computer (e.g., medical institution sever) making up the medical record management system can be provided as a medical record management program. The above program can be stored in a computer readable recording medium, and executed by the computer making up the medical record management system. Here, examples of the computer readable recording medium include an internal storage unit such as ROM or RAM which is internally packaged within the computer, a portable storage medium such as a CD-ROM, a flexible disk, a DVD disk, a magneto-optical disk or an IC card, a database holding the computer program, or another computer and the database, and the transmission media on communication lines.

What is claimed is:

1. A medical care record management system for managing the records of medical care covered by an insurance, comprising:
a first information acquisition part for acquiring first information that is information regarding the result of a medical care when a medical institution conducts the medical care for an insured person insured by the insurance;
a second information acquisition part for acquiring second information that is information integrating the information regarding the insured person with an digital signature of an insurer of the insurance generated based on the information regarding the insured person;
a third information generation part for generating third information that is information integrating the first information with an digital signature of the insured person by generating the digital signature of the insured person based on the first information; and
a fifth information generation part for generating fifth information that is information integrating fourth information including the second information and the third information, with an digital signature of the medical institution by generating the digital signature of the medical institution based on the fourth information.

2. The medical care record management system according to claim 1, further comprising a verification part for verifying the digital signature of the medical institution included in the fifth information, the digital signature of the insured person included in the second information, and the digital signature of the insurer included in the third information.

3. The medical care record management system according to claim 1, wherein the third information generation part generates the third information if an acknowledgement of the first information by the insured person is acquired.

4. The medical care record management system according to claim 1, wherein the second information acquisition part acquires the second information from a storage medium holding the second information, if the storage medium is made readable by the second information acquisition part.

5. The medical care record management system according to claim 1, wherein the digital signature is information in which a summary of information as an object of the digital signature is encrypted by a private key of the person who dictates the digital signature.

6. The medical care record management system according to claim 5, wherein the information regarding the insured person includes a certificate of a public key for verifying the digital signature of the insured person.

7. The medical care record management system according to claim 5, wherein the portable storage medium further holds the private key for generating the digital signature of the insured person.

8. The medical care record management system according to claim 1, wherein the fifth information generation part calculates an amount claimed for the insurer based on the second information and the third information and includes the amount claimed in the fourth information.

9. The medical care record management system according to claim 1, wherein the fifth information generation part calculates an amount claimed for the insured person based on the second information and the third information and includes the amount claimed in the fourth information.

10. The medical care record management system according to claim 9, wherein the information regarding the insured person may include a subsidy certificate indicating that the insured person is subject to public subsidy, and the fifth information generation part calculates an amount claimed for the insured person based on the subsidy certificate.

11. A recording medium recording a medical care record management program, the medical care record management program causing a computer to perform the steps of:
acquiring first information that is information regarding the result of medical care when the medical institution conducts the medical care for an insured person insured by the insurance;
acquiring second information that is information integrating the information regarding the insured person with an digital signature of an insurer of the insurance generated based on the information regarding the insured person;
generating third information that is information integrating the first information with an digital signature of the insured person by generating the digital signature of the insured person based on the first information, if an acknowledgement of the first information by the insured person is acquired; and
generating fifth information that is information integrating fourth information including the second information and the third information, with an digital signature of the medical institution by generating the digital signature of the medical institution based on the fourth information.

12. The recording medium recording the medical care record management program according to claim 11, wherein the medical care record management program further causes a computer to perform a step of verifying the digital signature of the medical institution included in the fifth information, the digital signature of the insured person included in the second information, and the digital signature of the insurer included in the third information.

13. The recording medium recording the medical care record management program according to claim 11, wherein the medical care record management program further causes a computer to perform a step of generating the third information if an acknowledgement of the first information by the insured person is acquired.

14. The recording medium recording the medical care record management program according to claim 11, wherein the medical care record management program further causes a computer to perform a step of acquiring the second information from a portable storage medium holding the second information, if the portable storage medium is made readable by the second information acquisition part.

15. A recording medium recording a medical care record management program, the medical care record management program causing a computer to perform the steps of:
acquiring first information that is information regarding the result of a medical care when a medical institution conducts the medical care for an insured person insured by an insurance;
acquiring second information that is information integrating the information regarding the insured person with an digital signature of an insurer of the insurance generated based on the information regarding the insured person;
generating third information that is information integrating the first information with an digital signature of the insured person by generating the digital signature of the insured person based on the first information, if an acknowledgement of the first information by the insured person is acquired; and
generating fifth information that is information integrating fourth information including the second information and the third information, with an digital signature of the medical institution by generating the digital signature of the medical institution based on the fourth information.

16. The recording medium recording the medical care record management program according to claim 15, wherein the medical care record management program further causes a computer to perform a step of verifying the digital signature of the medical institution included in the fifth information, the digital signature of the insured person included in the second information, and the digital signature of the insurer included in the third information.

17. The recording medium recording the medical care record management program according to claim 16, wherein the medical care record management program further causes a computer to perform a step of generating the third information if an acknowledgement of the first information by the insured person is acquired.

18. The recording medium recording the medical care record management program according to claim 17, wherein the medical care record management program further causes a computer to perform a step of acquiring the second information from a portable storage medium holding the second information if the portable storage medium is made readable by the second information acquisition part.
